(19) United States
(12) Patent Application Publication
(10) Pub. No.: US 2025/0284538 A1
(43) Pub. Date: Sep. 11, 2025

(54) DATA PROCESSING METHOD AND APPARATUS, CHIP, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Zimu REN, Shenzhen (CN)

(21) Appl. No.: 19/214,690

(22) Filed: May 21, 2025

Related U.S. Application Data
(63) Continuation of application No. PCT/CN2024/080205, filed on Mar. 6, 2024.

(30) Foreign Application Priority Data
Apr. 27, 2023 (CN) 202310481576.3

(51) Int. Cl. G06F 9/48; G06F 9/54

(52) U.S. Cl. CPC G06F 9/4881; G06F 9/542; G06F 2209/541

(57) ABSTRACT

Embodiments of this application provide a data processing method and apparatus to implement decoupling of vector processing and scalar processing. The data processing method includes generating a vector instruction queue according to a plurality of vector instructions in an instruction bundle after execution of a scalar instruction in the instruction bundle is completed; decoding a first instruction in the vector instruction queue to obtain a control signal set and an instruction code of the first instruction, the first instruction being a vector instruction in the vector instruction queue; broadcasting the control signal set to a vector processing unit, and detecting the first instruction according to the instruction code to obtain a detection result; issuing the first instruction to the vector processing unit when the detection result indicates that the first instruction is allowed to be issued; and executing the first instruction according to the control signal set.

### RELATED APPLICATIONS

This application is a continuation of PCT Application No. PCT/CN2024/080205, filed on Mar. 6, 2024, which in turn claims priority to Chinese Patent Application No. 2023104815763, entitled “DATA PROCESSING METHOD AND APPARATUS, AND CHIP” filed with the China National Intellectual Property Administration on Apr. 27, 2023, which are both incorporated herein by reference in their entirety.

### FIELD OF THE TECHNOLOGY

This application relates to the field of computers, and in particular, to data processing.

### BACKGROUND OF THE DISCLOSURE

A vector processor can process multiple channels of data in parallel in a single clock cycle, has a high degree of parallelism, and is an important component of an artificial intelligence (AI) processor. Currently, an AI processor usually uses a single instruction multi-data (SIMD) technology, i.e., uses one instruction to control the execution of multiple data paths, which is widely applied to image processing, and reasoning and training of neural networks.

To match the high computing power in an AI computing scenario, the parallelism of the AI processor is high. However, an excessively high parallelism causes many problems and poses great pressure on the layout and wiring during chip implementation.

Therefore, it is necessary to design an AI processor with a high-performance vector processing architecture.

### SUMMARY

Embodiments of this application provide a data processing method and apparatus, and a chip, to implement decoupling of vector processing from scalar processing, thereby reducing the overall complexity of the design and verification of an AI processor.

In view of this, one aspect of this application provides A data processing method, executed by a server, the method includes generating a vector instruction queue according to a plurality of vector instructions in an instruction bundle after execution of a scalar instruction in the instruction bundle is completed; decoding a first instruction in the vector instruction queue to obtain a control signal set and an instruction code of the first instruction, the control signal set and the instruction code indicating execution information of the first instruction, and the first instruction being a vector instruction in the vector instruction queue; broadcasting the control signal set to a vector processing unit, and detecting the first instruction according to the instruction code to obtain a detection result; issuing the first instruction to the vector processing unit when the detection result indicates that the first instruction is allowed to be issued; and executing the first instruction by the vector processing unit according to the control signal set.

Another aspect of this application provides a data processing apparatus, which includes a vector instruction queue unit, a decoding unit, a broadcast unit, a detection unit, an issue unit, and a vector processing unit. The vector instruction queue unit is configured to generate a vector instruction queue according to a plurality of vector instructions in an instruction bundle after execution of a scalar instruction in the instruction bundle is completed. The decoding unit is configured to decode a first instruction in the vector instruction queue generated by the vector instruction queue unit to obtain a control signal set and an instruction code of the first instruction, transmit the control signal set to the broadcast unit, and transmit the instruction code to the detection unit, the control signal set and the instruction code indicating execution information of the first instruction, and the first instruction being a vector instruction in the vector instruction queue. The broadcast unit is configured to broadcast the control signal set to the vector processing unit. The detection unit is configured to detect the first instruction according to the instruction code to obtain a detection result. The issue unit is configured to issue the first instruction to the vector processing unit when the detection unit determines that the first instruction is allowed to be issued. The vector processing unit is configured to execute the first instruction according to the control signal set.

Another aspect of this application provides a non-transitory computer-readable storage medium, having a computer program stored therein. The computer program, when it runs on a computer, causes the computer to execute the method of the above aspects.

The embodiments of the present disclosure have the following advantages. After execution of a scalar instruction is completed, a vector instruction queue is generated according to vector instructions, and the vector instruction queue is executed. Accordingly, as long as execution of a vector instruction is completed, write-back of the execution result corresponding to the vector instruction can be implemented. Therefore, embodiments of the present disclosure decouple vector processing from scalar processing, thereby further reduce the overall complexity of the complexity of the design and verification of an AI processor.

BRIEF DESCRIPTION OF THE DISCLOSURE

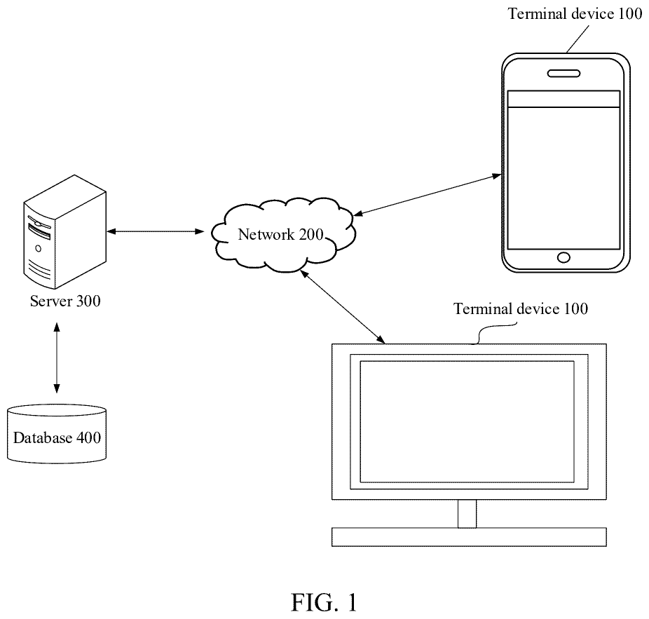

FIG. 1 is a schematic architectural diagram of a communication system according to an embodiment of this application;

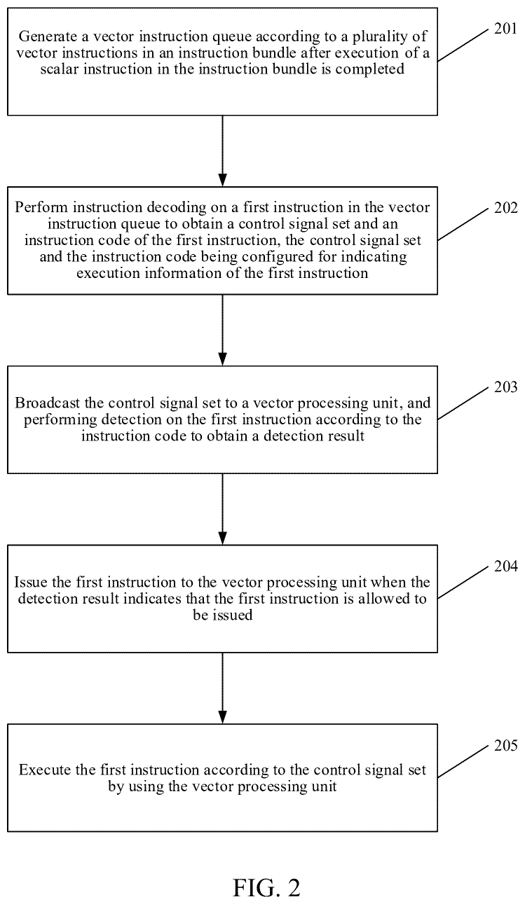

FIG. 2 is a schematic diagram of a data processing method according to an embodiment of this application;

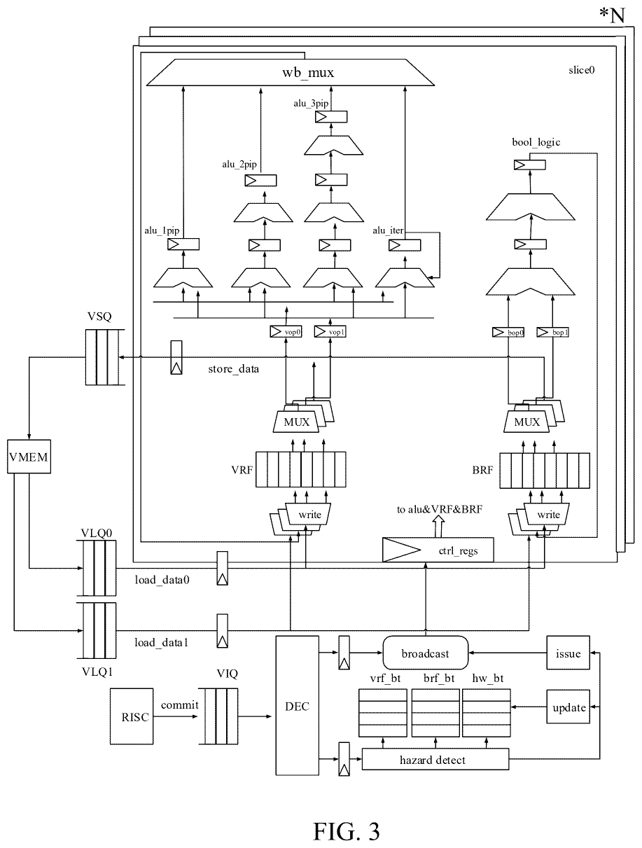

FIG. 3 is a schematic architectural diagram of a vector processor according to an embodiment of this application;

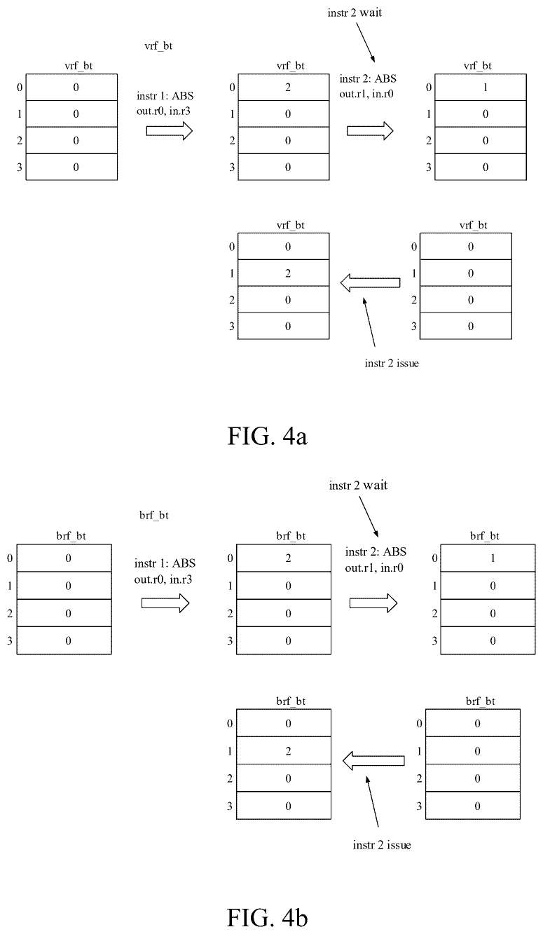

FIG. 4a is a schematic flowchart of performing status detection on a vector register according to an embodiment of this application;

FIG. 4b is a schematic flowchart of performing status detection on a Boolean register according to an embodiment of this application;

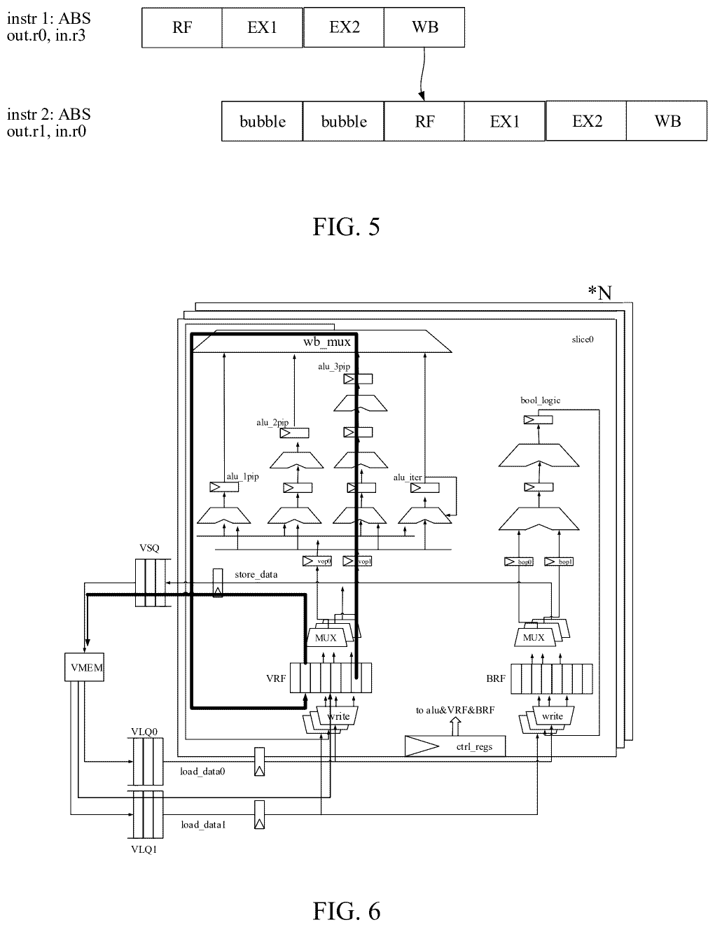

FIG. 5 is a schematic diagram of a dependency timing graph of instructions according to an embodiment of this application;

FIG. 6 is a schematic diagram of data flow directions of data processing performed by a vector processor according to an embodiment of this application;

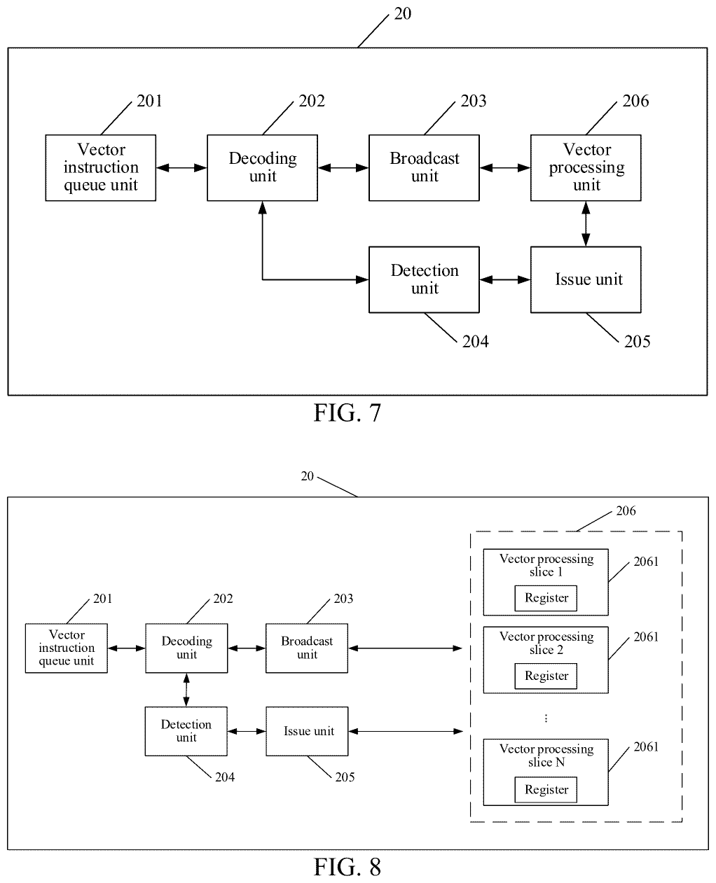

FIG. 7 is a schematic diagram of a data processing apparatus according to an embodiment of this application;

FIG. 8 is a schematic diagram of a data processing apparatus according to an embodiment of this application;

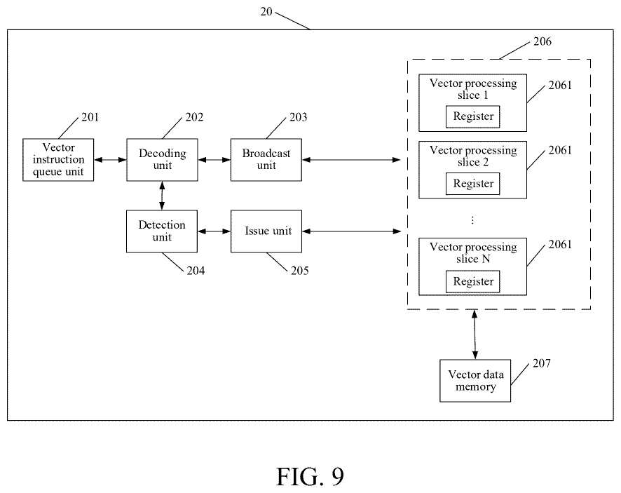

FIG. 9 is a schematic diagram of a data processing apparatus according to an embodiment of this application;

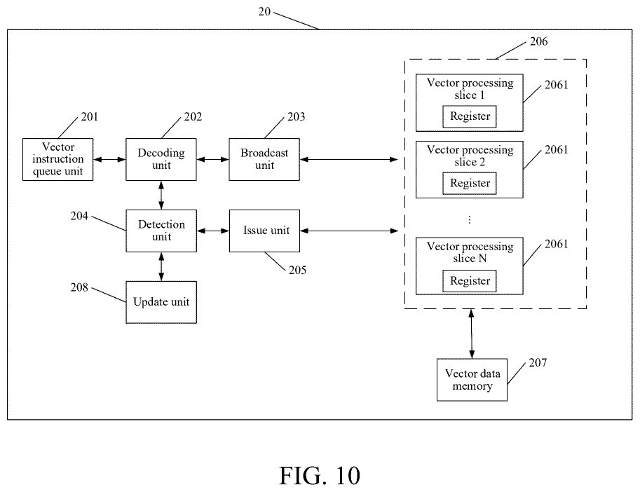

FIG. 10 is a schematic diagram of a data processing apparatus according to an embodiment of this application;

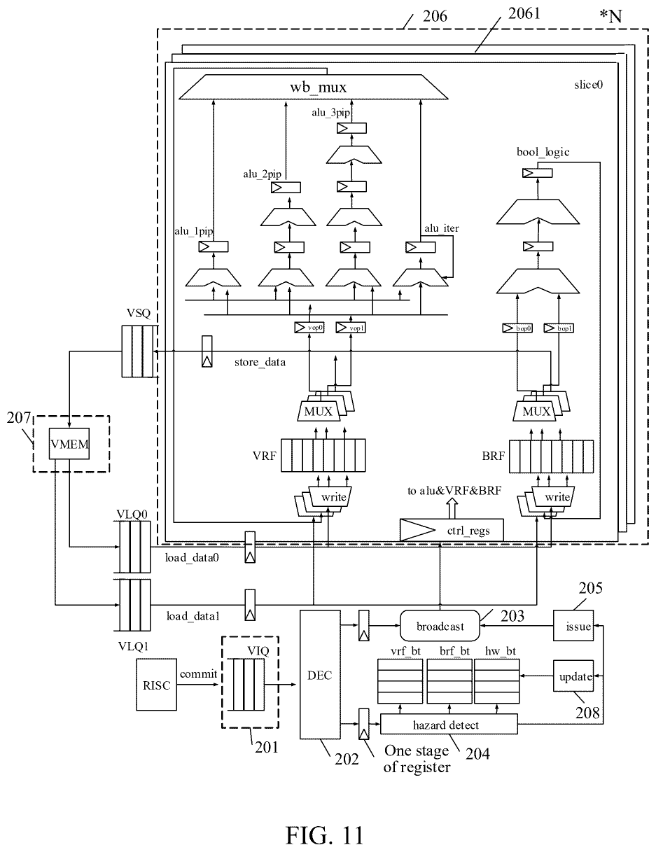

FIG. 11 is a schematic diagram of a data processing apparatus according to an embodiment of this application;

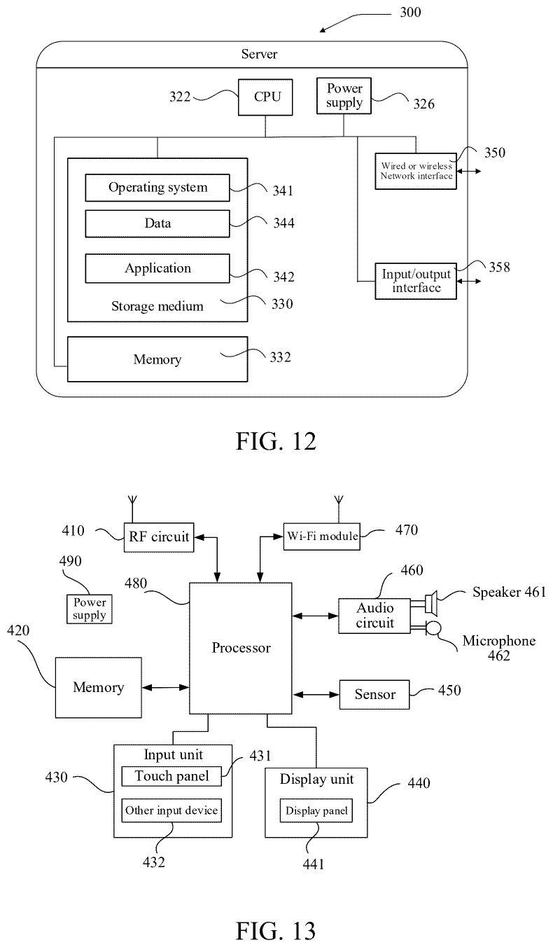

FIG. 12 is a schematic diagram of a data processing apparatus according to an embodiment of this application; and

FIG. 13 is a schematic diagram of a data processing apparatus according to an embodiment of this application.

### DESCRIPTION OF EMBODIMENTS

Embodiments of this application provide a data processing method and apparatus, and a chip, to implement decoupling of vector processing from scalar processing, thereby reducing the overall complexity of the design and verification of an AI processor.

In the specification, claims, and accompanying drawings of this application, the terms “first”, “second”, “third”, “fourth”, and so on (if any) are intended to distinguish between similar objects but do not necessarily indicate a specific order or sequence. It is to be understood that the data termed in such a way are interchangeable in appropriate circumstances, so that the embodiments of this application described herein can be implemented in orders other than the order illustrated or described herein. Moreover, the terms “including”, “corresponding to” and any variant thereof are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device.

A vector processor can process multiple channels of data in parallel in a single clock cycle, has a high degree of parallelism, and is an important component of an AI processor. Currently, an AI processor usually uses a SIMD technology, and is widely applied to image processing, and reasoning and training of neural networks. To match the high computing power in an AI computing scenario, the parallelism of the AI processor is relatively high. However, an excessively high parallelism causes many problems and poses great pressure on the layout and wiring during chip implementation. Therefore, currently, it is necessary to design an AI processor with a high-performance vector processing architecture.

To resolve the technical problem, this application provides the following technical solution: generating a vector instruction queue according to a plurality of vector instructions in an instruction bundle after execution of a scalar instruction in the instruction bundle is completed; performing instruction decoding on a first instruction in the vector instruction queue to obtain a control signal set and an instruction code of the first instruction, the control signal set and the instruction code being configured for indicating execution information of the first instruction; broadcasting the control signal set to a vector processing unit, and performing detection on the first instruction according to the instruction code to obtain a detection result; issuing the first instruction to the vector processing unit when the detection result indicates that the first instruction is allowed to be issued; and executing the first instruction according to the control signal set by using the vector processing unit. Based on the above, after execution of a scalar instruction is completed, a vector instruction queue is generated according to vector instructions, and the vector instruction queue is executed. Accordingly, as long as execution of a vector instruction is completed, write-back of the execution result corresponding to the vector instruction can be implemented. Therefore, decoupling of vector processing from scalar processing is achieved, thereby further reducing the overall complexity of the design and verification of an AI processor.

This application relates to AI-related technologies. AI is a theory, method, technology, and application system that uses a digital computer or a machine controlled by the digital computer to simulate, extend, and expand human intelligence, perceive an environment, acquire knowledge, and use knowledge to obtain optimal results. In other words, AI is a comprehensive technology in computer science. This technology attempts to understand the essence of intelligence and produce a new intelligent machine that can react in a manner similar to human intelligence. AI is to study the design principles and implementation methods of various intelligent machines, so that the machines can perceive, infer, and make decisions.

AI technology is a comprehensive subject, involving a wide range of fields including both hardware and software technologies. Basic AI technologies generally include technologies such as a sensor, a dedicated AI chip, cloud computing, distributed storage, big data processing technology, operation/interaction system, mechatronics, and the like. AI software technologies mainly include computer vision technology, speech processing technology, natural language processing technology, machine learning/deep learning, etc.

This application relates to machine learning in AI. Machine learning (ML) is a multi-field inter-discipline and relates to a plurality of disciplines such as the probability theory, statistics, the approximation theory, convex analysis, and the algorithm complexity theory. Machine learning specializes in studying how a computer simulates or implements a human learning behavior to acquire new knowledge or skills, and reorganizes an existing knowledge structure, so as to keep improving its performance. Machine learning is the core of the AI, is a basic way to make the computer intelligent, and is applied to various fields of AI. Machine learning and deep learning generally include technologies such as an artificial neural network, a belief network, reinforcement learning, transfer learning, inductive learning, and learning from demonstrations.

Machine learning in this application may refer to that an instruction in this application may be an instruction configured for executing a task of a model, and the model may be obtained through machine learning.

Embodiments of this application provide a data processing method and apparatus, and a chip, to implement decoupling of vector processing from scalar processing, thereby reducing the overall complexity of the design and verification of an AI processor. Referring to FIG. 1, FIG. 1 is an schematic architectural diagram in an application scenario of a data processing method according to an embodiment of this application. A terminal device 100 is connected to a server 300 through a network 200. The server 300 is connected to a database 400. The network 200 may be a wide area network, a local area network, or a combination of thereof. A client configured to implement the data processing solution may be deployed on the terminal device 100. The client may run on the terminal device 100 in a browser, an independent application (APP), or the like.

The specific form of the client is not limited herein. The server 300 involved in this application may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal device 100 may be a smart phone, a tablet computer, a notebook computer, a palmtop computer, a personal computer, a smart television, a smart watch, an in-vehicle device, or a wearable device, but is not limited thereto. The terminal device 100 and the server 300 may be directly or indirectly connected through the network 200 in a wired or wireless communication manner, which is not limited by the embodiments disclosed in this application. The number of servers 300 and the number of terminal devices 100 are also not limited. The solution provided in this application may be independently implemented by the terminal device 100, by the server 300, or by the terminal device 100 and the server 300, which is not specifically limited in this application. The database 400 may be considered as an electronic file cabinet where an electronic file is stored, and a user may perform operations such as adding, querying, updating, deleting and the like on data in the file. The so-called “database” is data sets that are stored together in a certain manner, can be shared with multiple users, have as little redundancy as possible, and is independent of the application. Database management systems (DBMSs) are computer software systems designed for managing databases, and generally have basic functions such as storage, interception, security guarantee, backup and the like. Database management systems may be classified according to the database model supported, e.g., relational and Extensible Markup Language (XML); or classified according to the computer type supported, e.g., server cluster or mobile phone; or classified according to the query language used, e.g., Structured Query Language (SQL) or XQuery; or classified according to the performance indicator, e.g., maximum scale and highest running speed; or classified by other methods. Regardless of which classification method is used, some DBMSs can fall into multiple categories at the same time, e.g., support multiple query languages at the same time. In this application, the database 400 may be configured to store vector data. Certainly, the vector data is not limited to being stored in the database, but may also be stored in, for example, the terminal device 100, a blockchain, a distributed file system of the server 300, or the like.

The following describes some of the technical terms used in the present disclosure.

Register (register file, RF): Registers are small storage areas configured for storing data inside a Central Processing Unit (CPU), and generally are configured for temporarily storing data participating in operations, operation results, and some information required for running of the CPU. Registers are usually classified into the following types.

General-purpose register: It is the most frequently used and the most fundamental type of register for executing code by a program. During the execution of the program, the general-purpose registers are operated to implement instruction functions most of time.

Flag register: It includes numerous flag bits and is configured for recording a series of states during execution of an instruction by the CPU. Most of these flag bits are automatically set and changed by the CPU.

Instruction register: It is the most important type of register in the CPU, and points to an address at which the next instruction to be executed is stored. In fact, the operation of the CPU is to continuously fetch an instruction to which the instruction register points and then execute the instruction, and the instruction register continues to point to the next instruction. The repeated execution of this process is the daily routine of the CPU.

Segment register: It is a type of register that stores content closely correlated to the current memory addressing mode of the CPU. When the CPU operates in a 16-bit real address mode, the segment register stores a segment base address, and during addressing, the content of the segment register is shifted leftward by 4 bits (multiplied by 16) to add an intra-segment offset to the segment base address, thus obtaining a final address. When the CPU operates in a protection mode, the content stored in the segment register is no longer a segment base address. In this case, the content stored in the segment register is a segment selector, which is used to indicate a segment to which the segment register file currently “points”.

The four types of registers, i.e., general-purpose registers, segment registers, flag registers, and instruction registers, together constitute a basic instruction execution environment. The context of a thread is substantially these registers, and thread switching is changing the content of these registers.

Single instruction multi-data (SIMD): It is a technology of using one controller to control multiple processors to respectively perform the same operation on each data item in a set of data (or referred to as “data vectors”), to achieve spatial parallelism. Generally, data-level parallelism (not concurrency) is used. In other words, there is only one instruction at a moment, but there are multiple simultaneous calculations, i.e., parallel calculations. SIMD is particularly applicable to some common tasks, for example, adjusting the contrast of a digital image, or adjusting the volume of a digital audio.

Very long instruction word (VLIW): It is an architecture commonly used in an AI processor, and is characterized in that an instruction bundle is issued at a time. The instruction bundle includes a plurality of instructions, which may be executed in parallel. The instruction bundle includes a vector instruction and a scalar instruction. The scalar instruction includes a process-type instruction to control the execution process of the instruction bundle. The main concept of introducing the very long instruction word to enable one instruction bundle to include both a vector instruction and a scalar instruction lies in that, multiple mutually independent instructions are encapsulated into an instruction word which is very long, there are a corresponding number of arithmetic and logic units (ALUs) in the CPU to implement corresponding instruction operations, and the dependency between and scheduling of the instructions is implemented by a compiler. Because a plurality of parallel operations are encapsulated in one instruction, the instruction is longer than a Reduced Instruction Set Computer (RISC) or Complex Instruction Set Computer (CISC) instruction, and thus named Very Long Instruction Set.

It may be understood that the embodiments of this application involve data such as instruction data. User permission or consent needs to be obtained before the embodiments of this application is applied to a specific product or technology, and the collection, use, and processing of the related data need to comply with related laws and regulations and standards of relevant countries and regions.

With reference to the foregoing descriptions, the data processing method in this application is described below by using a server as an entity that executes the method. Referring to FIG. 2, an embodiment of the data processing method in the embodiments of this application includes the following operations.

201: Generate a vector instruction queue according to a plurality of vector instructions in an instruction bundle after execution of a scalar instruction in the instruction bundle is completed.

In this embodiment, in an instruction preparation stage, an instruction bundle is generated from the scalar instruction and the vector instruction by using a very long instruction word, and then issued. Then, the scalar instruction in the instruction bundle is executed. After the scalar instruction is executed and committed, the vector instruction in the instruction bundle is pushed into a vector instruction queue. In some embodiments, the vector instruction queue may be executed based on a first-in-first-out principle.

In one embodiment, with reference to the architecture shown in FIG. 3, in an instruction preparation stage, an instruction bundle is generated from the scalar instruction and the vector instruction by using a very long instruction word, and then issued. Then, the RISC executes the scalar instruction in the instruction bundle. After executing and committing the scalar instruction, the RISC pushes the vector instruction in the instruction bundle into a vector instruction queue (VIQ). In this case, the vector instruction is decoupled from the scalar instruction in the vector instruction queue, thereby reducing the overall design and verification complexity of the processor.

202: Perform instruction decoding on a first instruction in the vector instruction queue to obtain a control signal set and an instruction code of the first instruction, the control signal set and the instruction code being configured for indicating execution information of the first instruction.

The server calls the instructions in the vector instruction queue based on a first-in-first-out principle. The server may use any vector instruction being called as a first instruction, then perform an instruction decoding operation on the called first instruction to obtain an instruction type of the first instruction, and then generate a control signal set and a corresponding instruction code of the first instruction according to the instruction type.

The control signal set includes, but is not limited to, a source register number, a destination register number, a data path mode control signal, a data path gating signal of the first instruction, etc.

The instruction code includes, but is not limited to, information such as an instruction name of the first instruction, a register entry in the register from which the first instruction reads data, and a register entry in the register to which the first instruction writes data in the register.

In one embodiment, with reference to the architecture shown in FIG. 3, an instruction is called from the VIQ, and passed to a decoder (DEC). The DEC performs an instruction decoding operation on the instruction, and obtains a control signal set and an instruction code that corresponds to the instruction according to the instruction type. Assuming that the first instruction is “instr1”, the instruction code may be “instr1: ABS out.r0, in.r3”, indicating that the instruction name of instr1 is ABS, data inputted by instr1 is read from an entry 0 in the register, and data outputted by instr1 is written into an entry 3 in the register.

203: Broadcast the control signal set to a vector processing unit, and perform detection on the first instruction according to the instruction code to obtain a detection result.

In this embodiment, the control signal set is registered and broadcast, so that the control signal set can be sent to the vector processing unit. Meanwhile, a dependency detection is performed on the first instruction according to the instruction code to obtain a detection result.

In one embodiment, when the vector processing unit includes N vector processing slices, a method of registering and broadcasting the control signal set may include:

copying the control signal set to obtain N identical control signal sets; and respectively broadcasting the N identical control signal sets to the N vector processing slices, N being a positive integer greater than 1, and each of the vector processing slices being corresponding to one control signal set. In this embodiment, because the N vector processing slices have the same structure, each vector processing slice can execute different data calculations of the first instruction, thereby increasing the efficiency of instruction execution by the vector processing unit.

In one embodiment, a method of performing a dependency detection on the first instruction according to the instruction code to obtain the detection result may include:

obtaining a source register number and a destination register number of the first instruction according to the instruction code, determining, according to the source register number and the destination register number, a register type to be used for the first instruction (e.g., determining, according to the source register number, that at least one of a vector register and a Boolean register is to be used for the first instruction), and determining, according to the instruction code, a hardware resource to be used for the first instruction; then obtaining a resource state table; then querying the resource state table for first state information of a register corresponding to the source register number, querying the resource state table for second state information of a register corresponding to the destination register number, and querying the resource state table for third state information of a hardware resource to be used for the first instruction, where the first state information, the second state information, and the third state information are each configured for indicating whether the corresponding register or the hardware resource is in an occupied or idle state; and finally determining the detection result according to the first state information, the second state information, and the third state information.

In this embodiment, for each instruction, a vector register and a hardware resource may be used, or a Boolean register and a hardware resource may be used, or a vector register, a Boolean register, and a hardware resource may be used. Therefore, the resource state table includes the following three tables.

vrf_bt: a vector register file busy table (or vector register state table) for indicating whether each register of the current vector register is in an occupied or idle state.

brf_bt: a Boolean register file busy table (or Boolean register state table) for indicating whether each register of the current Boolean register is in an occupied or idle state.

hw_bt: a hardware busy table for indicating whether a hardware resource reused in the vector processing unit is in an occupied or idle state.

For example, a method for performing a dependency detection according to the three tables may include:

determining, according to the vector register state table, state information of a vector register to be used for the first instruction.

In other words, when it is determined, according to the source register number and the destination register number that correspond to the instruction, that the type of the register to be used for the instruction is a vector register, the vector register state table is queried to determine whether the vector register to be used is in an occupied or idle state, to obtain state information corresponding to the vector register to be used.

As shown in FIG. 4a, the number of entries in the vrf_bt corresponds to the number of registers in the vrf. Four entries are used as an example for description. Each entry in the vrf_bt stores a counter, indicating the number of clock cycles after which the vrf register corresponding to the current entry will be idle. Initially, counters of all entries are set to 0, indicating an idle state. In this case, instr1 is issued. The instruction is an ABS instruction, with an output being an r0 register, and requiring two clock cycles for calculation. Therefore, when the ABS instruction is issued, entry0 of the vrf_bt is set to 2, and then the value of the entry0 is reduced by 1 every one clock cycle. In one clock cycle after the issue of instr1, instr2 enters the issue unit, a source register of instr2 being r0. It is found by querying the vrf_bt table that a counter of entry0 is currently not 0. Therefore, isntr2 cannot be issued before the counter of entry0 changes to 0.

In another example, a method for performing a dependency detection according to the three tables may include: determining, according to the Boolean register state table, state information of a Boolean register to be used for the first instruction.

In other words, when it is determined, according to the source register number and the destination register number that correspond to the instruction, that the type of the register to be used for the instruction is a Boolean register, the Boolean register state table is queried to determine whether the Boolean register to be used is in an occupied or idle state, to obtain state information corresponding to the Boolean register to be used.

As shown in FIG. 4b, the number of entries in the brf_bt corresponds to the number of registers in the brf. Four entries are used as an example for description. Each entry in the brf_bt stores a counter, indicating the number of clock cycles after which the brf register corresponding to the current entry will be idle. Initially, counters of all entries are set to 0, indicating an idle state. In this case, instr1 is issued. The instruction is an ABS instruction, with an output being an r0 register, and requiring two clock cycles for calculation. Therefore, when the ABS instruction is issued, entry0 of the vrf_bt is set to 2, and then the value of the entry0 is reduced by 1 every one clock cycle. In one clock cycle after the issue of instr1, instr2 enters the issue unit, a source register of instr2 being r0. It is found by querying the brf_bt table that a counter of entry0 is currently not 0. Therefore, isntr2 cannot be issued until the counter of entry0 changes to 0.

In another example, a method for performing a dependency detection according to the three tables may include: determining, according to the hardware resource state table, state information of a hardware resource to be used for the first instruction.

In other words, a hardware resource to be used for the instruction is determined according to the instruction code corresponding to the instruction, and the hardware resource state table is queried to determine whether the hardware resource to be used is in an occupied or idle state, to obtain state information corresponding to the hardware resource to be used.

instr1 and instr2 in the vector processing unit reuse a multiplier resource. If instr1 is still using the multiplier, instr2 needs to wait, and cannot issue instr2 until instr1 has completed the use of the multiplier resource.

After the dependency detection, a dependency timing graph may further be determined for each instruction according to the detection result. For the scenario shown in FIG. 4a, a dependency timing graph of instr1 and instr2 may be shown in FIG. 5. instr1 corresponds to the first row in FIG. 5, and instr2 corresponds to the second row in FIG. 5. Using the first row as an example, RF (register file) represents a stage in which the register of instr1 reads data, EX (Execute) 1 and EX2 represent an instruction execution stage of instr1, and WB (write back) represents a write-back stage of the calculation result of the instruction. Two bubbles need to be waited before instr2 is issued, as shown in the second row. instr2 cannot be issued until the calculation result of instr1 has been written back to the register.

The bubble may be understood as a waiting time interval for issuing instr2. In the instruction execution stage, the waiting time interval may be calculated based om clock cycles. For example, in the scenario shown in FIG. 5, when execution of instr1 starts, instr2 is passed into the issue preparation unit, in which case instr2 needs to wait for two clock cycles. If the execution stage of instr1 requires only one clock cycle, instr2 needs to wait for only one clock cycle.

When multiple register and hardware resources are used, the largest one of the numbers of clock cycles required by the resources may be determined as the waiting time interval for issuing the instruction. For example, it is determined in the hardware resource that instr2 needs to wait for two clock cycles, it is determined according to the state information of the vector register that instr2 needs to wait for three clock cycles, and it is determined according to the state information of the Boolean register that instr2 needs to wait for two clock cycles. In this case, the waiting time interval for instr2 may be set to three clock cycles.

After the state information is obtained, the detection result is determined through comprehensive analysis according to the state information. Details are as follows.

It is determined that the detection result is that the first instruction is allowed to be issued, when the first state information indicates that the register corresponding to the source register number is in an idle state, the second state information indicates that the register corresponding to the destination register number is in an idle state, and the hardware resource indicated by the third state information is in an idle state.

It is determined that the detection result is that the first instruction is not allowed to be issued, when the first state information indicates that the register corresponding to the source register number is in an occupied state, the second state information indicates that the register corresponding to the destination register number is in an occupied state, and/or the hardware resource indicated by the third state information is in an occupied state.

In one embodiment, with reference to the architecture shown in FIG. 3, the DEC unit sends an instruction code (opcode) of an instruction to a hazard detection (hazard detect) unit, and performs an instruction dependency check. For a specific check process, reference can be made to the foregoing process, and the details will not be repeated herein. Meanwhile, the DEC unit registers each control signal in the control signal set once (i.e., through one stage of register, e.g., hw_bt, as shown in FIG. 3) and then passes the control signal set to a broadcast unit for broadcasting, i.e., the control signal set is copied to generate N control signal sets, each of which is broadcast to one corresponding vector processing slice.

After the control signal set is broadcast to the vector processing slice, the control signal set may further be written to a register corresponding to the vector processing slice for registering. For example, the control signal set is inputted to “ctrl_regs” shown in FIG. 3 for registering. Accordingly, each vector processing slice can read the control signal from the local register, thereby ensuring good timing of the instructions, and the vector processing slices are independent of each other, thereby resolving the instruction congestion problem during data processing.

204: Transmit the first instruction to the vector processing unit when the detection result indicates that the first instruction is allowed to be issued.

The first instruction is issued to the vector processing unit when the detection result indicates that the first instruction is allowed to be issued.

In this embodiment, after it is determined that the detection result indicates that the first instruction is allowed to be issued, the resource state table may further be updated. As such, the resource state table can be updated in a timely manner, so that a more accurate detection result can be obtained by performing a dependency detection on the instruction by determining whether the registers are in an occupied or an idle state. Accordingly, an ordered issue of the instructions can be achieved, and the fan-out problem can be effectively reduced, thereby facilitating layout and wiring.

205: Execute the first instruction according to the control signal set by using the vector processing unit.

The vector processing unit includes N vector processing slices having the same structure, each slice being configured to process one path of data in the vector calculation indicated by the first instruction. For example, the first instruction indicates a calculation operation of adding to 100,000 pixels in an image, and the number of vector processing slices is 10. In this case, 10 pixels are calculated in each round of calculation, and only 10,000 times of calculation are required to process the 100,000 pixels.

Each slice includes two sets of registers: VRF and BRF, which have their respective read and write ports. In one embodiment, as shown in FIG. 3, read and write ports of the VRF and read and write ports of the BRF may adopt a 3-read 3-write interface design, the three read ports being respectively used for op0, op1, and vector store operations, and the three write ports being respectively used for calculation instruction write-back and two vector load operations. In addition, each slice includes a plurality of execution paths that are set according to the number of pipeline stages, the plurality of execution paths form the execution path set, and each execution path in the execution path set allows for write-back of the calculation result.

In one embodiment, with reference to the architecture shown in FIG. 3, the slice is divided into four different execution paths according to the number of pipeline stages of the vector instruction; alu_1pip being configured for processing an operation instruction requiring only one pipeline stage, alu_2pip being configured for processing an operation instruction requiring two pipeline stages, alu_3pip being configured for processing an operation instruction requiring three pipeline stages, and alu_iter being configured for processing an operation instruction that needs to be iterated. In addition, calculation data obtained through processing of the four execution paths is written back to the VRF by one wb_mux.

Execution of the first instruction by the slice described above may specifically include:

first obtaining a number of pipeline stages of the first instruction according to the instruction type of the first instruction; then selecting a target execution path from the execution path set according to the number of pipeline stages, the data path mode control signal, and the data path gating signal; then reading to-be-processed data from the register corresponding to the source register number, and sending the to-be-processed data to the target execution path; then performing calculation on the to-be-processed data by using the target execution path to obtain a calculation result of the first instruction; and then writing back the calculation result to the register corresponding to the destination register number. In one embodiment, it is assumed that the instruction code obtained by decoding the first instruction is “instr1: ABS out.r0, in.r3”, and the control signal set includes “read from r3 in register, write to r0 in register, select alu_1pip, and gate alu_1pip”. In this case, it may be determined that the instruction type of the first instruction is an ABS instruction, and at the same time, it may be determined according to the instruction type that the ABS instruction requires one pipeline stage. In addition, the data path mode control signal is configured for instructing the vector processing slice to select the alu_1pip path shown in FIG. 3, and the data path gating signal is configured for gating the alu_1pip path shown in FIG. 3. Then, the vector processing slice reads corresponding to-be-processed data from r3 in the register, an ALU of the alu_1pip path performs calculation on the to-be-processed data to obtain a calculation result. Finally, the calculation result is written to r0 of the register through the wb_mux of the alu_1pip path.

Because the number of pipeline stages of the first instruction can directly identify the number of execution stages into which the execution of the first instruction is divided, the target execution path suitable for the first instruction can be accurately selected from the execution path set according to the data path mode control signal and the data path gating signal, thereby improving the execution efficiency of the first instruction.

In this embodiment, the data processing apparatus 20 may further include a vector data memory. In this case, the to-be-processed data and the calculation result may be stored in the storage unit. Therefore, during execution of the first instruction, the register corresponding to the source register number may first read the to-be-processed data from the vector data memory through a load instruction, and write same to the register corresponding to the source register number. When the execution of the first instruction is completed, the register corresponding to the destination register number may write the calculation result to the vector data memory through a store instruction.

Processes for processing data of a vector register and a Boolean register are respectively described below with reference to the architecture shown in FIG. 6.

In this embodiment, data loading and writing of the VRF and the BRF are implemented using a load/store instruction. The load instruction supports dual issues, i.e., two load instructions can be executed simultaneously. The store instruction only supports a single issue. This is because most vector instructions are of a 2-in-1-out type, for example, a vector addition instruction.

VMEM represents a vector memory configured to store vector data. Under control of a load instruction, the vector data is read from the VMEM through a vector load queue (VLQ), and then is written to the VRF or the BRF. The calculation result is read from the VRF or the BRF through a store instruction, passes through a vector store queue (VSQ), and is written to the VMEM.

### 1. Vector Register

When it is determined that the first instruction is an operation instruction requiring three pipeline stages, the alu_3pip execution path shown in FIG. 6 is selected. Then, to-be-processed data is read from the VMEM through a vector load instruction, passes through VLQ0/1, and is written to the VRF. Then, by executing the first instruction (or referred to as a vector execution instruction), the to-be-processed data is read, and is subjected to logic calculation by alu_3pip to obtain a calculation result, and the calculation result is written back to the VRF. Finally, the calculation result is read from the VRF through a vector store instruction, passes through a VSQ, and is written back to the VMEM.

### 2. Boolean Register

When it is determined that Boolean data needs to be processed in the first instruction, a two-stage execution path of a Boolean register shown in FIG. 6 is selected. Then, to-be-processed data is read from the VMEM through a vector load instruction, passes through VLQ0/1, and is written to the BRF. Then, by executing the first instruction (or referred to as a vector execution instruction), the to-be-processed data is read, and is subjected to logic calculation by the two-stage execution path of the Boolean register to obtain a calculation result, and the calculation result is written back to the BRF. Finally, the calculation result is read from the BRF through a vector store instruction, passes through a VSQ, and is written back to the VMEM.

The following describes a data processing apparatus in this application in detail. Referring to FIG. 7, FIG. 7 is a schematic diagram of a data processing apparatus according to an embodiment of this application. The data processing apparatus 20 includes a vector instruction queue unit 201, a decoding unit 202, a broadcast unit 203, a detection unit 204, an issue unit 205, and a vector processing unit 206.

The vector instruction queue unit 201 is configured to generate a vector instruction queue according to a plurality of vector instructions in an instruction bundle after execution of a scalar instruction in the instruction bundle is completed.

The decoding unit 202 is configured to perform instruction decoding on a first instruction in the vector instruction queue generated by the vector instruction queue unit 201 to obtain a control signal set and an instruction code of the first instruction, transmit the control signal set to the broadcast unit 203, and transmit the instruction code to the detection unit 204, the control signal set and the instruction code being configured for indicating execution information of the first instruction.

The broadcast unit 203 is configured to broadcast the control signal set to the vector processing unit 206.

The detection unit 204 is configured to perform detection on the first instruction according to the instruction code to obtain a detection result.

The issue unit 205 is configured to issue the first instruction to the vector processing unit 206 when the detection unit 204 determines that the detection result indicates that the first instruction is allowed to be issued.

The vector processing unit 206 is configured to execute the first instruction according to the control signal set.

In an embodiment of this application, a data processing apparatus is provided. With the apparatus, after execution of a scalar instruction is completed, a vector instruction queue is generated according to vector instructions, and the vector instruction queue is executed. Accordingly, as long as execution of a vector instruction is completed, write-back of the execution result corresponding to the vector instruction can be implemented. Therefore, decoupling of vector processing from scalar processing is achieved, thereby further reducing the overall complexity of the design and verification of an AI processor.

In some embodiments, based on the embodiment corresponding to FIG. 7, in another embodiment of the data processing apparatus 20 provided in the embodiments of this application,

the broadcast unit 203 is configured to copy the control signal set to generate N control signal sets; and

broadcast the N control signal sets to N vector processing slices 2061 of the vector processing unit 206 in a one-to-one correspondence, N being a positive integer greater than 1, and the N vector processing slices 2061 having the same structure.

In an embodiment of this application, a data processing apparatus is provided. With the apparatus, the vector processing unit is divided into a plurality of slices having the same structure, thereby improving the vector processing efficiency.

In some embodiments, based on the embodiment corresponding to FIG. 7, as shown in FIG. 8, in another embodiment of the data processing apparatus 20 provided in the embodiments of this application, each of the N vector processing slices 2061 corresponds to a register, and each of the N vector processing slices 2061 are configured to write the control signal set broadcast by the broadcast unit to the corresponding register.

In an embodiment of this application, a data processing apparatus is provided. With the apparatus, a control signal of each slice comes from a local register of the slice. Accordingly, the slice can execute instructions with good timing, and the control signals of the slices are independent of each other, thereby resolving the congestion problem during instruction execution.

In some embodiments, based on the embodiment corresponding to FIG. 8, in another embodiment of the data processing apparatus 20 provided in the embodiments of this application,

the N vector processing slices 2061 are configured to execute the first instruction according to the control signal set.

In an embodiment of this application, a data processing apparatus is provided. With the apparatus, the vector processing unit is divided into a plurality of slices having the same structure, thereby improving the vector processing efficiency. In addition, a control signal of each slice comes from a local register of the slice. Accordingly, the slice can execute instructions with good timing, and the control signals of the slices are independent of each other, thereby resolving the congestion problem during instruction execution.

In some embodiments, based on the embodiment corresponding to FIG. 8, in another embodiment of the data processing apparatus 20 provided in the embodiments of this application,

the control signal set includes a source register number, a destination register number, a data path mode control signal, and a data path gating signal of the first instruction, and the vector processing slice 2061 is configured to obtain a number of pipeline stages of the first instruction;

select a target execution path from an execution path set according to the number of pipeline stages, the data path mode control signal, and the data path gating signal, the execution path set including a plurality of execution paths, and the execution path being an instruction execution path that is set according to the number of pipeline stages of an instruction in a vector processing slice; and

execute the first instruction according to the target execution path, the source register number, and the destination register number.

In an embodiment of this application, a data processing apparatus is provided. With the apparatus, different instruction execution paths are set in each slice according to the number of pipeline stages, a corresponding execution path is selected for an instruction according to the number of pipeline stages of the instruction, and different execution paths are all written back to a register. Accordingly, out-of-order write-back of different instructions is achieved, thereby reducing the power consumption and improving the processing performance.

In some embodiments, based on the embodiment corresponding to FIG. 8, in another embodiment of the data processing apparatus 20 provided in the embodiments of this application, the vector processing slice 2061 is configured to read to-be-processed data of the first instruction according to the source register number;

perform calculation on the to-be-processed data by using the target execution path to obtain a calculation result of the first instruction; and

write the calculation result of the first instruction according to the destination register number.

In an embodiment of this application, a data processing apparatus is provided. With the apparatus, different instruction execution paths are set in each slice according to the number of pipeline stages, a corresponding execution path is selected for an instruction according to the number of pipeline stages of the instruction, and different execution paths are all written back to a register. Accordingly, out-of-order write-back of different instructions is achieved, thereby reducing the power consumption and improving the processing performance.

In some embodiments, based on the embodiment corresponding to FIG. 8, as shown in FIG. 9, in another embodiment of the data processing apparatus 20 provided in the embodiments of this application, the data processing apparatus 20 further includes a vector data memory 207, configured to store the to-be-processed data and the calculation result; and the vector processing slice 2061 is configured to read the to-be-processed data from the vector data memory 207 and write the to-be-processed data to a register corresponding to the source register number, through a load instruction; and

read the calculation result from a register corresponding to the destination register number and write the calculation result into the vector data memory 207 through a store instruction.

In an embodiment of this application, a data processing apparatus is provided. With the apparatus, a dedicated memory is used to store calculation results of vector instructions, so that the storage duration and storage security of the calculation results can be improved.

Based on the embodiment corresponding to FIG. 7, FIG. 8, or FIG. 9, in another embodiment of the data processing apparatus 20 provided in the embodiments of this application, the detection unit 204 is further configured to obtain a resource state table, and obtain a source register number and a destination register number of the first instruction according to the instruction code;

query the resource state table for first state information of a register corresponding to the source register number, query the resource state table for second state information of a register corresponding to the destination register number, and query the resource state table for third state information of a hardware resource to be used for the first instruction; and

determine the detection result according to the first state information, the second state information, and the third state information.

In an embodiment of this application, a data processing apparatus is provided. With the apparatus, before the vector instruction is issued to the slice, a dependency detection is first performed on the vector instruction. Accordingly, the fan-out problem can be effectively reduced, thereby facilitating layout and wiring.

In some embodiments, based on the embodiment corresponding to FIG. 7, FIG. 8, or FIG. 9, in another embodiment of the data processing apparatus 20 provided in the embodiments of this application,

the detection unit 204 is configured to query a vector register state table for the first state information of a register corresponding to the source register number, and query the vector register state table for the second state information of the register corresponding to the destination register number, the vector register state table being included in the resource state table;

or

query a Boolean register state table for the first state information of the register corresponding to the source register number, and query the Boolean register state table for the second state information of the register corresponding to the destination register number, the Boolean register state table being included in the resource state table;

or

query a vector register state table for first information of the register corresponding to the source register number, query the vector register state table for second information of the register corresponding to the destination register number,

query a Boolean register state table for third information of the register corresponding to the source register number, and query the Boolean register state table for fourth information of the register corresponding to the destination register number,

the first information and the third information being used as the first state information, the second information and the fourth information being used as the second state information, and the vector register state table and the Boolean register state table being included in the resource state table.

In an embodiment of this application, a data processing apparatus is provided. With the apparatus, the dependency detection on the instruction is implemented by determining whether the registers are in an occupied or and idle state. Accordingly, an ordered issue of the instructions can be achieved, and the fan-out problem can be effectively reduced, thereby facilitating layout and wiring.

In some embodiments, based on the embodiment corresponding to FIG. 7, FIG. 8, or FIG. 9, in another embodiment of the data processing apparatus 20 provided in the embodiments of this application, the detection unit 204 is further configured to determine that the detection result is that the first instruction is allowed to be issued, when the first state information indicates that the register corresponding to the source register number is in an idle state, the second state information indicates that the register corresponding to the destination register number is in an idle state, and the hardware resource indicated by the third state information is in an idle state; and

determine that the detection result is that the first instruction is not allowed to be issued, when the first state information indicates that the register corresponding to the source register number is in an occupied state, the second state information indicates that the register corresponding to the destination register number is in an occupied state, and/or the hardware resource indicated by the third state information is in an occupied state.

In an embodiment of this application, a data processing apparatus is provided. With the apparatus, the dependency detection on the instruction is implemented by determining whether the registers are in an occupied or an idle state. Accordingly, an ordered issue of the instructions can be achieved, and the fan-out problem can be effectively reduced, thereby facilitating layout and wiring.

In some embodiments, based on the embodiment corresponding to FIG. 7, FIG. 8, or FIG. 9, in another embodiment of the data processing apparatus 20 provided in the embodiments of this application, the detection unit 204 is further configured to determine a waiting time interval for issuing the first instruction according to the first state information, the second state information, and the third state information, when the detection result indicates that the first instruction is not allowed to be issued.

In an embodiment of this application, a data processing apparatus is provided. With the apparatus, the dependency detection on the instruction is implemented by determining whether the registers are in an occupied or an idle state. Accordingly, an ordered issue of the instructions can be achieved, and the fan-out problem can be effectively reduced, thereby facilitating layout and wiring.

In some embodiments, based on the embodiment corresponding to FIG. 7, FIG. 8, or FIG. 9, as shown in FIG. 10, in another embodiment of the data processing apparatus 20 provided in the embodiments of this application, the data processing apparatus 20 further includes an update unit 208, configured to update the resource state table after the detection unit 204 determines that the detection result indicates that the first instruction is allowed to be issued.

In an embodiment of this application, a data processing apparatus is provided. With the apparatus, the resource state table is updated in a timely manner, so that a more accurate detection result can be obtained by performing a dependency detection on the instruction by determining whether the registers are in an occupied or an idle state. Accordingly, an ordered issue of the instructions can be achieved, and the fan-out problem can be effectively reduced, thereby facilitating layout and wiring.

The data processing apparatus is described below using an exemplary architecture shown in FIG. 11.

As shown in FIG. 11, the VIQ is equivalent to the vector instruction queue unit 201 shown in FIG. 7 to FIG. 10. The DEC equivalent to the decoding unit 202 shown in FIG. 7 to FIG. 9. The broadcast is equivalent to the broadcast unit 203 shown in FIG. 7 to FIG. 10. The hazard detect is equivalent to the detection unit 204 shown in FIG. 7 to FIG. 9. The issue is equivalent to the issue unit 205 in FIG. 7 to FIG. 10. slice0 to sliceN are equivalent to the N vector processing slices 2061. In this case, slice0 to sliceN form the vector processing unit 206. The VMEM is equivalent to the vector data memory 207 shown in FIG. 9. The update is equivalent to the update unit 208 shown in FIG. 10.

Based on the architecture shown in FIG. 11, a process of executing the vector instruction in this application is described below.

After the RISC executes the scalar instruction in the instruction bundle and commits the scalar instruction, the data processing apparatus 20 writes the vector instruction to the VIQ, and then generates the vector instruction queue through the VIQ. The vector instruction queue is executed based on a first-in-first-out principle in the VIQ.

During execution of the vector instructions, the vectors in the VIQ are sequentially transmitted to the DEC, and the DEC performs a decoding operation on each input vector instruction, to obtain a control signal set and an instruction code that correspond to the vector instruction. The control signal set and the instruction code may both be configured for indicating execution information corresponding to the vector instruction, e.g., a data reading source, a calculation result writing location, the instruction type of the vector instruction, the data path selection signal, the data path selection signal and the data path gating signal of the vector instruction in the vector processing unit, and the like during execution of the vector instruction. After obtaining the control signal set and the instruction code, the DEC transmits the control signal set to the broadcast, and transmits the instruction code to the hazard detect. When transmitting the control signal set to the broadcast, the DEC may also register the control signal set through one stage of register, and then transmits the control signal set to the broadcast. Similarly, when transmitting the instruction code to the hazard detect, the DEC may also register the instruction code through one stage of register, and then transmits the instruction code to the hazard detect.

The broadcast copies the control signal set, and then respectively sends the copies of the control signal set to slice0 to sliceN. Each vector processing slice corresponds to one copy of the control signal set. In addition, each vector processing slice corresponds to one register, i.e., ctrl_regs, which stores the control signal set.

The hazard detect performs a dependency detection on the vector instruction according to the instruction code, i.e., determines whether a register resource and a hardware resource to be used for the vector instruction are idle, and when both the register resource and the hardware resource are idle, determines that the vector instruction is allowed to be issued. Specifically, for a specific process of performing the dependency detection on the vector instruction by the hazard detect according to the instruction code, reference can be made to the description of step 203, and the details will not be repeated herein.

When the hazard detect determines that the vector instruction is allowed to be issued, the issue sends the vector instruction to slice0 to sliceN, and at the same time, the update updates the resource state table.

The specific structure of the vector processing slice may be as shown in FIG. 11. Each slice includes two sets of registers: VRF and BRF, which have their respective read and write ports. In one embodiment, as shown in FIG. 11, read and write ports of the VRF and read and write ports of the BRF may adopt a 3-read 3-write interface design, the three read ports being respectively used for op0, op1, and vector store operations, and the three write ports being respectively used for calculation instruction write-back and two vector load operations. In addition, each slice includes a plurality of execution paths that are set according to the number of pipeline stages, the plurality of execution paths form the execution path set, and each execution path in the execution path set allows for write-back of the calculation result. In one embodiment, with reference to the architecture shown in FIG. 11, the slice is divided into four different execution paths according to the number of pipeline stages of the instruction; alu_1pip being configured for processing an operation instruction requiring only one pipeline stage, alu_2pip being configured for processing an operation instruction requiring two pipeline stages, alu_3pip being configured for processing an operation instruction requiring three pipeline stages, and alu_iter being configured for processing an operation instruction that needs to be iterated. In addition, calculation data obtained through processing of the four execution paths is written back to the VRF by one wb_mux. In one embodiment, for the execution of the vector instruction by the vector processing slice, reference can be made to the description of step 205, and the details will not be repeated herein.

The VMEM is configured to store vector data. For execution of a vector instruction, the VMEM may be configured to store to-be-processed data of the vector instruction and a calculation result of the vector instruction. For a specific execution process, reference can be made to the description of step 205, and the details will not be repeated herein.

The data processing apparatus provided in this application may be applied to a server. FIG. 12 is a schematic structural diagram of a server according to an embodiment of this application. The server 300 may vary greatly due to different configurations or performance, and may include one or more central processing units (CPU) 322 (e.g., one or more processors) and a memory 332, and one or more storage medium 330 (e.g., one or more mass storage devices) that store application programs 342 or data 344. The memory 332 and the storage medium 330 may be transient or persistent storages. The program stored in the storage medium 330 may include one or more modules (not marked in the figure), and each module may include a series of instruction operations to the server. Further, the CPU 322 may be configured to communicate with the storage medium 330, and perform, on the server 300, the series of instruction operations in the storage medium 330.

The server 300 may further include one or more power supplies 326, one or more wired or wireless network interfaces 350, one or more input/output interfaces 358, and/or one or more OSs 341, for example, Windows Server™, Mac OS X™, Unix™, Linux™, or FreeBSD™.

The steps performed by the data processing apparatus in the foregoing embodiment may be based on the server structure shown in FIG. 12.

The data processing apparatus provided in this application may be applied to a terminal device. Referring to FIG. 13, for ease of description, only a part related to this embodiment of this application is shown. For a specific technical detail not disclosed, refer to the method part in the embodiments of this application. In an embodiment of this application, an example where the terminal device is a smart phone is described.

FIG. 13 is a block diagram of a structure of a part of a smart phone related to a terminal device according to an embodiment of this application. Referring to FIG. 13, the smart phone includes components such as: a radio frequency (RF) circuit 410, a memory 420, an input unit 430, a display unit 440, a sensor 450, an audio circuit 460, a wireless fidelity (WiFi) module 470, a processor 480, and a power supply 490. A person skilled in the art may understand that the structure of the smart phone shown in FIG. 13 does not constitute a limitation on the mobile phone, and the smart phone may include more components or fewer components than those shown in the figure, or some components may be combined, or a different component deployment may be used.

The following makes a detailed description of the components of the smart phone with reference to FIG. 13:

The RF circuit 410 may receive and send a signal during an information receiving and sending process or a conversation process. Specifically, the RF circuit 410 receives downlink information from a base station, then delivers the downlink information to the processor 480 for processing, and sends related uplink data to the base station. Generally, the RF circuit 410 includes, but is not limited to, an antenna, at least one amplifier, a transceiver, a coupler, a low noise amplifier (LNA), a duplexer, and the like. In addition, the RF circuit 410 may also communicate with a network and another device by wireless communication. The wireless communication may use any communications standard or protocol, which includes, but is not limited to, a Global System for Mobile communications (GSM), General Packet Radio Service (GPRS), Code Division Multiple Access (CDMA), Wideband Code Division Multiple Access (WCDMA), Long Term Evolution (LTE), email, Short Messaging Service (SMS), and the like.

The memory 420 may be configured to store a software program and module. The processor 480 runs the software program and module stored in the memory 420, to implement various functional applications and data processing of the smart phone. The memory 420 may mainly include a program storage area and a data storage area. The program storage area may store an operating system, an application program required by at least one function (such as a sound playback function and an image display function), and the like. The data storage area may store data (such as audio data and an address book) created according to use of the smart phone, and the like. In addition, the memory 420 may include a high speed random access memory, and may also include a non-volatile memory, such as at least one magnetic disk storage device, a flash memory device, or another volatile solid storage device.

The input unit 430 may be configured to receive inputted digit or character information, and generate a keyboard signal input related to the user setting and function control of the smart phone. Specifically, the input unit 430 may include a touch panel 431 and another input device 432. The touch panel 431 may also be referred to as a touchscreen, and may collect a touch operation of a user on or near the touch panel (such as an operation of a user on or near the touch panel 431 using any suitable object or attachment, such as a finger or a stylus), and drive a corresponding connection apparatus according to a preset program. In some embodiments, the touch panel 431 may include two parts: a touch detection apparatus and a touch controller. The touch detection apparatus detects a touch orientation of the user, detects a signal generated by the touch operation, and transfers the signal to the touch controller. The touch controller receives the touch information from the touch detection apparatus, converts the touch information into touch point coordinates, and sends the touch point coordinates to the processor 480. Moreover, the touch controller may receive and execute a command sent from the processor 480. In addition, the touch panel 431 may be implemented using various types, such as a resistive type, a capacitance type, an infrared type, and a surface acoustic wave type. In addition to the touch panel 431, the input unit 430 may further include another input device 432. Specifically, another input device 432 may include, but is not limited to, one or more of a physical keyboard, a functional key (such as a volume control key or a switch key), a track ball, a mouse, and a joystick.

The display unit 440 may be configured to display information inputted by the user or information provided for the user, and various menus of the smart phone. The display unit 440 may include a display panel 441. In some embodiments, the display panel 441 may be configured using a liquid crystal display (LCD), an organic light-emitting diode (OLED), or the like. Further, the touch panel 431 may cover the display panel 441. After detecting a touch operation on or near the touch panel 431, the touch panel 431 transfers the touch operation to the processor 480, so as to determine a type of a touch event. Then, the processor 480 provides corresponding visual output on the display panel 441 according to the type of the touch event. Although in FIG. 13, the touch panel 431 and the display panel 441 are used as two separate parts to implement input and input functions of the smart phone, in some embodiments, the touch panel 431 and the display panel 441 may be integrated to implement the input and output functions of the smart phone.

The smart phone may further include at least one sensor 450, such as an optical sensor, a motion sensor, and other sensors. Specifically, the optical sensor may include an ambient light sensor and a proximity sensor. The ambient light sensor may adjust luminance of the display panel 441 according to brightness of the ambient light. The proximity sensor may switch off the display panel 441 and/or backlight when the smart phone is moved to the ear. As one type of motion sensor, an accelerometer sensor may detect the magnitude of accelerations in various directions (which generally are three axes), may detect the magnitude and a direction of the gravity when static, and may be applied to applications that require identifying the posture of the smart phone (such as switchover between horizontal and vertical screens, a related game, and posture calibration of a magnetometer) and vibration identification-related functions (such as a pedometer and a knock). Other sensors, such as a gyroscope, a barometer, a hygrometer, a thermometer, and an infrared sensor, which may be configured in the smart phone are not further described in detail herein.

The audio circuit 460, a speaker 461, and a microphone 462 may provide audio interfaces between the user and the smart phone.

The processor 480 is a control center of the smart phone, and connects to various parts of the smart phone using various interfaces and lines. By running or executing the software program and/or module stored in the memory 420, and invoking data stored in the memory 420, the processor 480 performs various functions and data processing of the smart phone, thereby performing overall monitoring on the smart phone.

The smart phone further includes the power supply 490 (such as a battery) for supplying power to the components. In some embodiments, the power supply may be logically connected to the processor 480 by using a power management system, thereby implementing functions such as charging, discharging and power consumption management by using the power management system.

Although not shown in the figure, the smart phone may further include a camera, a Bluetooth module, and the like, which are not further described herein.

An embodiment of this application further provides a computer-readable storage medium, storing a computer program which, when it runs on a computer, causes the computer to execute the methods described in the foregoing embodiments.

An embodiment of this application further provides a computer program product including a program, the program, when run on a computer, causing the computer to perform the methods according to the foregoing embodiments.

An embodiment of this application further provides a chip, which is configured to execute the data processing method shown in FIG. 2 and includes the data processing apparatus described above shown in FIG. 7 to FIG. 11.

Persons skilled in the art may clearly understand that, for the purpose of convenient and brief description, for a detailed working process of the system, apparatus, and unit described above, refer to a corresponding process in the method embodiments, and details are not described herein again.

In the several embodiments provided in the present disclosure, it should be understood that the disclosed system, apparatus, and method may be implemented in other manners. For example, the described apparatus embodiments are only exemplary. For example, the division of the units is merely a logical function division and other division manners may be used in practical implementations. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate. Parts displayed as units may or may not be physical units, and may be located in one position, or may be distributed on a plurality of network units. Some or all of the units may be selected based on actual requirements to achieve the objectives of the solutions of embodiments.

In addition, functional units in the embodiments of this application may be integrated into one processing unit, each of the units may exist alone physically, or two or more units are integrated into one unit. The integrated unit may be implemented in the form of hardware, or may be implemented in the form of a software functional unit.

The integrated unit may be stored in a computer-readable storage medium if implemented in the form of a software functional unit and sold or used as an independent product. Based on such an understanding, the technical solutions of this application essentially, or the part contributing to the related art, or all or some of the technical solutions may be implemented in the form of a software product. The software product is stored in a storage medium, and includes several instructions for instructing a computer device (which may be a personal computer, a server, a network device, or the like) to execute all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, a compact disc, or the like.

In conclusion, the foregoing embodiments are merely intended for describing the technical solutions of this application, but not for limiting this application. Although this application is described in detail with reference to the foregoing embodiments, a person of ordinary skilled in the art should understand that modifications may still be made to the technical solutions described in the foregoing embodiments or equivalent replacements may be made to some technical features, and such modifications or replacements do not cause the essence of the corresponding technical solutions to depart from the spirit and scope of embodiments of this application.

What is claimed is:

1. A data processing method, executed by a server, the method comprising:
generating a vector instruction queue according to a plurality of vector instructions in an instruction bundle after execution of a scalar instruction in the instruction bundle is completed;
decoding a first instruction in the vector instruction queue to obtain a control signal set and an instruction code of the first instruction, the control signal set and the instruction code indicating execution information of the first instruction, and the first instruction being a vector instruction in the vector instruction queue;
broadcasting the control signal set to a vector processing unit, and detecting the first instruction according to the instruction code to obtain a detection result;
issuing the first instruction to the vector processing unit when the detection result indicates that the first instruction is allowed to be issued; and
executing the first instruction by the vector processing unit according to the control signal set.

2. The method according to claim 1, wherein the broadcasting the control signal set to a vector processing unit comprises:
copying the control signal set to generate N control signal sets; and
broadcasting the N control signal sets to N vector processing slices of the vector processing unit in a one-to-one correspondence, N being a positive integer greater than 1, and the N vector processing slices having the same structure.

3. The method according to claim 2, wherein the control signal set comprises a source register number, a destination register number, a data path mode control signal, and a data path gating signal of the first instruction, and the executing the first instruction by the vector processing unit according to the control signal set comprises:
obtaining a number of pipeline stages of the first instruction;
selecting a target execution path from an execution path set according to the number of pipeline stages, the data path mode control signal, and the data path gating signal, the execution path set comprising a plurality of execution paths, and the execution path being set according to the number of pipeline stages of a vector instruction in a vector processing slice; and
executing the first instruction according to the target execution path, the source register number, and the destination register number.

4. The method according to claim 3, wherein the executing the first instruction according to the target execution path, the source register number, and the destination register number comprises:
reading to-be-processed data of the first instruction according to the source register number;
calculating the to-be-processed data by using the target execution path to obtain a calculation result of the first instruction; and
writing the calculation result of the first instruction according to the destination register number.

5. The method according to claim 1, wherein the detecting the first instruction according to the instruction code to obtain a detection result comprises:
obtaining a resource state table, and obtaining a source register number and a destination register number of the first instruction according to the instruction code;
querying the resource state table for first state information of a register corresponding to the source register number, querying the resource state table for second state information of a register corresponding to the destination register number, and querying the resource state table for third state information of a hardware resource to be used for the first instruction; and
determining the detection result according to the first state information, the second state information, and the third state information.

6. The method according to claim 5, wherein the determining the detection result according to the first state information, the second state information, and the third state information comprises:
determining that the detection result is that the first instruction is allowed to be issued, when the first state information indicates that the register corresponding to the source register number is in an idle state, the second state information indicates that the register corresponding to the destination register number is in an idle state, and the hardware resource indicated by the third state information is in an idle state; and
determining that the detection result is that the first instruction is not allowed to be issued, when the first state information indicates that the register corresponding to the source register number is in an occupied state, the second state information indicates that the register corresponding to the destination register number is in an occupied state, and/or the hardware resource indicated by the third state information is in an occupied state.

7. The method according to claim 6, further comprising:
determining a waiting time interval for issuing the first instruction according to the first state information, the second state information, and the third state information, when the detection result indicates that the first instruction is not allowed to be issued.

8. A data processing apparatus, comprising:
a vector instruction queue unit, a decoding unit, a broadcast unit, a detection unit, an issue unit, and a vector processing unit, wherein
the vector instruction queue unit is configured to generate a vector instruction queue according to a plurality of vector instructions in an instruction bundle after execution of a scalar instruction in the instruction bundle is completed;
the decoding unit is configured to decode a first instruction in the vector instruction queue generated by the vector instruction queue unit to obtain a control signal set and an instruction code of the first instruction, transmit the control signal set to the broadcast unit, and transmit the instruction code to the detection unit, the control signal set and the instruction code indicating execution information of the first instruction, and the first instruction being a vector instruction in the vector instruction queue;
the broadcast unit is configured to broadcast the control signal set to the vector processing unit;
the detection unit is configured to detect the first instruction according to the instruction code to obtain a detection result;
the issue unit is configured to issue the first instruction to the vector processing unit when the detection unit determines that the first instruction is allowed to be issued; and
the vector processing unit is configured to execute the first instruction according to the control signal set.

9. The apparatus according to claim 8, wherein the broadcast unit is configured to:
copy the control signal set to generate N control signal sets; and
broadcast the N control signal sets to N vector processing slices of the vector processing unit in a one-to-one correspondence, N being a positive integer greater than 1, and the N vector processing slices having the same structure.

10. The apparatus according to claim 9, wherein each of the N vector processing slices corresponds to a register, and each of the N vector processing slices are configured to write the control signal set broadcast by the broadcast unit to the corresponding register.

11. The apparatus according to claim 10, wherein the N vector processing slices are configured to execute the first instruction according to the control signal set.

12. The apparatus according to claim 11, wherein the control signal set comprises a source register number, a destination register number, a data path mode control signal, and a data path gating signal of the first instruction, and the N vector processing slices are further configured to:
obtain a number of pipeline stages of the first instruction;
select a target execution path from an execution path set according to the number of pipeline stages, the data path mode control signal, and the data path gating signal, the execution path set comprising a plurality of execution paths, and the execution path being an instruction execution path that is set according to the number of pipeline stages of a vector instruction in a vector processing slice; and
execute the first instruction according to the target execution path, the source register number, and the destination register number.

13. The apparatus according to claim 12, wherein the N vector processing slices are further configured to read to-be-processed data of the first instruction according to the source register number;
calculate the to-be-processed data by using the target execution path to obtain a calculation result of the first instruction; and
write the calculation result of the first instruction according to the destination register number.

14. The apparatus according to claim 13, further comprising a vector data memory, configured to store the to-be-processed data and the calculation result, wherein the N vector processing slices are configured to read the to-be-processed data from the vector data memory and write the to-be-processed data to a register corresponding to the source register number, through a load instruction; and
read the calculation result from a register corresponding to the destination register number and write the calculation result into the vector data memory through a store instruction.

15. The apparatus according to claim 8, wherein the detection unit is configured to obtain a resource state table, and obtain a source register number and a destination register number of the first instruction according to the instruction code;
query the resource state table for first state information of a register corresponding to the source register number, query the resource state table for second state information of a register corresponding to the destination register number, and query the resource state table for third state information of a hardware resource to be used for the first instruction; and
determine the detection result according to the first state information, the second state information, and the third state information.

16. The apparatus according to claim 15, wherein the detection unit is configured to query a vector register state table for the first state information of a register corresponding to the source register number, and query the vector register state table for the second state information of the register corresponding to the destination register number, the vector register state table being comprised in the resource state table;
the detection unit is configured to query a Boolean register state table for the first state information of the register corresponding to the source register number, and query the Boolean register state table for the second state information of the register corresponding to the destination register number, the Boolean register state table being comprised in the resource state table;
or
the detection unit is configured to query a vector register state table for first information of the register corresponding to the source register number, query the vector register state table for second information of the register corresponding to the destination register number,
query a Boolean register state table for third information of the register corresponding to the source register number, and query the Boolean register state table for fourth information of the register corresponding to the destination register number,
the first information and the third information being the first state information, the second information and the fourth information being the second state information, and the vector register state table and the Boolean register state table being comprised in the resource state table.

17. The apparatus according to claim 15, wherein the detection unit is configured to determine that the detection result is that the first instruction is allowed to be issued, when the first state information indicates that the register corresponding to the source register number is in an idle state, the second state information indicates that the register corresponding to the destination register number is in an idle state, and the hardware resource indicated by the third state information is in an idle state; and
determine that the detection result is that the first instruction is not allowed to be issued, when the first state information indicates that the register corresponding to the source register number is in an occupied state, the second state information indicates that the register corresponding to the destination register number is in an occupied state, and/or the hardware resource indicated by the third state information is in an occupied state.

18. The apparatus according to claim 17, wherein the detection unit is further configured to determine a waiting time interval for issuing the first instruction according to the first state information, the second state information, and the third state information, when the detection result indicates that the first instruction is not allowed to be issued.

19. The apparatus according to claim 15, further comprising an update unit, configured to update the resource state table after the detection unit determines that the detection result indicates that the first instruction is allowed to be issued.

20. A non-transitory computer-readable storage medium, configured to store a computer program, the computer program being configured to execute a data processing method, executed by one or more processors, the method comprising:
generating a vector instruction queue according to a plurality of vector instructions in an instruction bundle after execution of a scalar instruction in the instruction bundle is completed;
decoding a first instruction in the vector instruction queue to obtain a control signal set and an instruction code of the first instruction, the control signal set and the instruction code indicating execution information of the first instruction, and the first instruction being a vector instruction in the vector instruction queue;
broadcasting the control signal set to a vector processing unit, and detecting the first instruction according to the instruction code to obtain a detection result;
issuing the first instruction to the vector processing unit when the detection result indicates that the first instruction is allowed to be issued; and
executing the first instruction by the vector processing unit according to the control signal set.
